(19) United States
(12) Patent Application Publication
(10) Pub. No.: US 2026/0060286 A1
(43) Pub. Date: Mar. 5, 2026

(54) A COMPOSITION FOR FAT-SOLUBLE VITAMINS AND PROCESS THEREOF

(71) Applicants: Pravin NALAWADE, Mumbai, Maharashtra (IN); Hemant PAGAR, Nahsik, Maharashtra (IN); Vlkrant SURYVANSHI, Thane, Maharashtra (IN)

(72) Inventors: Pravin NALAWADE, Mumbai, Maharashtra (IN); Hemant PAGAR, Nahsik, Maharashtra (IN); Vlkrant SURYVANSHI, Thane, Maharashtra (IN)

(21) Appl. No.: 18/578,013

(22) PCT Filed: Apr. 8, 2023
(86) PCT No.: PCT/IN2023/050343

§ 371 Date: Jan. 10, 2024

(30) Foreign Application Priority Data
Apr. 10, 2022 (IN) 202221021396

(51) Int. Cl. A23L 33/155; A23L 29/10; A23L 33/115

(52) U.S. Cl. CPC A23L 33/155; A23L 29/10; A23L 33/115

(57) ABSTRACT

The present invention relates to a composition comprising fat-soluble vitamins and at least one pharmaceutically and neutraceutically acceptable excipients. also, the invention further relates to composition of fat-soluble vitamins in amorphous form and the process of preparation thereof. An amorphous form composition is further exerted a high solubility and stability, as provided in the forgoing examples, which concomitantly results in a higher bioavailability. The present invention also comprises a composition of a fat-soluble vitamin, natural stabilizer/antioxidant, vegetable oil, a natural emulsifier, and polysaccharide, and optionally contains other vitamins and a mixture of vitamins. The composition comprising the fat-soluble vitamins is in amorphous form, which is water dispersible and highly stable, and bioavailable.

### FIELD OF THE INVENTION

The present invention relates to a composition comprising fat-soluble vitamins and other suitable pharmaceutical and nutraceutical excipients. Further invention relates to a composition of fat-soluble vitamins in amorphous form and the process of preparation thereof. The composition comprises fat-soluble vitamin, natural stabilizer/antioxidant, vegetable oil, a natural emulsifier, polysaccharide, and optionally contains other vitamins and a mixture of vitamins. The composition comprised of the fat-soluble vitamins is water dispersible and stable in nature.

### BACKGROUND OF THE INVENTION

Fat-soluble vitamins get absorbed by fats and travel through the bloodstream while water-soluble vitamins dissolve in water and get absorbed by tissues. The encapsulation of active compounds such as vitamins, essential oils and flavours in nutraceuticals and dietary supplements is becoming an emerging trend for research and development. Vitamins A, D, E, and K are called the fat-soluble vitamins, because they are soluble in organic solvents and are absorbed and transported in a manner similar to that of fats. Fat-soluble vitamins are absorbed with the other fats from the food you eat. When they're absorbed in this way, they go with the fats and are stored in your body's fat tissue and liver. Fat-soluble vitamins can stay in your body for a while. The use of fat-soluble vitamins is limited in all food fortifications due to low stability and water dispersibility. The fat-soluble vitamins are mostly hydrophobic with limited water solubility, and they are often sensitive to environmental conditions. Therefore, encapsulation of fat-soluble vitamins within hydrophilic food grade matrices enhances their water solubility and bioavailability and increases their shelf life by improving their stability against temperature, light and oxygen etc. There are several methods developed for encapsulation of vitamins such as emulsion, extrusion, co-precipitation, coacervation, spray-drying, freeze-drying, electro spraying and electrospinning. Each encapsulation approach results in different structures and morphologies and therefore the physicochemical and delivery of these fat-soluble vitamins is different from each other. Although so many approached been studied, very few able to succeed on commercial scale due to limitations with respect to stability and solubility of fat-soluble vitamins in various food fortification formats. The present invention relates to amorphous composition of fat-soluble vitamins using vegetable oils, natural stabilizer/antioxidant, natural emulsifier and polysaccharide matrix. The amorphous form of vitamins is-highly stabilized and dispersible or soluble in water to be used in various applications in food fortifications. The increase in water solubility may further result into increased bioavailability.

US20060057214A1 [Sylvain Diguet et al.] provides a process for the production of cross-linked beadlets containing one or more active ingredients selected from the group of a fat-soluble vitamin active material, a carotenoid and a polyunsaturated fatty acid, the process comprising treating a dry particulate form at a temperature in the range of from 90° C. to 140° C. for a time period of from 30 seconds to 30 minutes or from 1 minute to 10 minutes or from 3 minutes to 7 minutes.

EP3139904A1 [Inger Reidun Aukrust et al.] discloses invention related to a composition comprising A) microcapsules comprising at least one fat-soluble active substance selected from a vitamin K compound or a provitamin or a prodrug of a vitamin K compound embedded in a matrix comprising a hydrocolloid and optionally one or more other matrix components, and B) at least one dietary mineral; as well as uses and products comprising such compositions.

Celebioglu A, Uyar T. et al (Food Funct. 2020 Sep. 23; 11 (9): 7626-7637) discloses polymer-free Vitamin-A acetate/cyclodextrin nanofibrous web with increased solubility. The encapsulation of food/dietary supplements into electrospun cyclodextrin (CD) inclusion complex nanofibers paves the way for developing novel carrying and delivery substances along with orally fast-dissolving properties. In this study, CD inclusion complex nanofibers of Vitamin-A acetate were fabricated from polymer-free aqueous systems by using the electrospinning technique. The hydroxypropylated (HP) CD derivatives of HPβCD and HPγCD were used for both encapsulation of Vitamin-A acetate and the electrospinning of free-standing nanofibrous webs. The ultimate Vitamin-A acetate/CD nanofibrous webs (NWs) were obtained with a loading capacity of 5% (w/w).

What is, therefore, now needed in the art is one or more bioavailable amorphous formulations of fat-soluble vitamins that are stable, have a desirable solubility profile, and are amenable to manufacturing conditions.

From the above overall background, we do not reach the prior art which speaks about this instant invention, more particularly to the stable composition comprising an amorphous form of fat-soluble vitamins and the process for preparation thereof.

### OBJECT OF THE INVENTION

A primary object of the present invention is to provide a composition in the amorphous form of fat-soluble vitamin. The obtained fat-soluble vitamin composition is stable and more bioavailable.

Another object of the present invention is to provide the process for the preparation of the fat-soluble vitamin composition in amorphous form.

Still, another object of the present invention is to provide an amorphous form of fat-soluble vitamin composition to be used in sprinkles, micronutrient premixes, tablets, capsules, and food fortification like salt, rice and wheat flour, etc.

### SUMMARY OF THE INVENTION

The present invention relates to a composition comprising fat-soluble vitamins and at least one pharmaceutically and nutraceutically acceptable excipients.

Further, the invention relates to composition of fat-soluble vitamins in amorphous form and the process of preparation thereof.

The present invention also comprises a composition of a fat-soluble vitamin, natural stabilizer/antioxidant, vegetable oil, a natural emulsifier, and polysaccharide, and optionally contains other vitamins and a mixture of vitamins. The composition comprising the fat-soluble vitamins is in amorphous form, which is water dispersible and highly stable, and bioavailable.

### BRIEF DESCRIPTION OF DRAWINGS

FIG. 1: X ray diffractogram of vitamin A acetate is in crystalline form.

FIG. 2: X ray diffractogram of composition of vitamin A acetate is in amorphous form, (example 1)

FIG. 3. DSC thermograms of Vitamin A acetate exhibited a sharp thermal peak at 53.6° C., which is its melting point hence it indicates the crystalline form.

FIG. 4: DSC thermogram of Vitamin A composition (Beadlets—Example 1), shows the complete disappearance of melting endothermic in Vitamin A composition (Beadlets) is indicative of the formation of an amorphous system, which results in highly soluble and stabilized vitamin beadlets. This may further give improved bioavailability due to its highly soluble nature.

FIG. 5: DSC thermogram of Vitamin D3 exhibited a sharp thermal peak at 83.6° C., which is its melting point hence it indicates the crystalline form.

FIG. 6: DSC thermogram of Vitamin D3 beadlets (Example 3), shows a complete disappearance of melting endothermic in Vitamin D3 composition (Beadlets) is indicative of the formation of an amorphous system, which results in highly soluble and stabilized vitamin beadlets. This may further give improved bioavailability due to its highly soluble nature.

FIG. 7: X ray diffractogram of vitamin D3 in crystalline form.

FIG. 8: X-ray diffractogram of the composition of vitamin D3 in amorphous form. (Example 3)

### DETAILED DESCRIPTION OF THE INVENTION

Fat-soluble vitamins disclosed in the invention are vitamins A, D, E, and K, and it is present in foods containing fats. The body absorbs these vitamins as it does dietary fats, it does not dissolve in water. There are two types: water-soluble and fat-soluble vitamins, and water-soluble vitamins are vitamins B and C, and fat-soluble vitamins are A, D, E, and K. Vitamins help the body function effectively.

Most vitamins come from food, but sunshine contributes to vitamin D. Some people need or choose to take supplements that provide extra vitamins. The body absorbs fat-soluble vitamins best when a person eats them with higher-fat foods. Fat-soluble vitamins are vitamins that get absorbed by fats and travel through the bloodstream, while water-soluble vitamins dissolve in water and get absorbed by tissues.

The present invention relates to a composition comprising fat-soluble vitamins and other pharmaceutical and nutraceutically acceptable excipients.

Further, the invention relates to a composition of fat-soluble vitamins in amorphous form and the process of preparation thereof.

The composition comprises fat-soluble vitamins selected from A, D, E, and K and/or their derivatives. Further comprises suitable excipients selected from encapsulating agents, Solubilizers for vitamins, Stabilizers, emulsifiers, and solubilizers for an encapsulating agent.

According to the present invention, the composition also provides a water-dispersible composition which results in stability in nature with longer shelf life.

An encapsulating agent used in the composition is selected from gelatin-like modified starch, dextrin derivatives, sugars, gums, modified cellulose, xanthan gum, acacia gum, pectin, guar, maltodextrin, alginate, and a mixture thereof.

An encapsulating agent present in the composition is about 40% to 99% w/w but preferably about 70 to 99% w/w.

A solubilizer is selected from a group of vegetable oils like palm oil, soyabean oil, coconut oil, sunflower oil, rapeseed oil, olive oil, corn oil, MCT oil, and a mixture thereof.

A solubilizer present in the composition is about 5 to 40% w/w but preferably about 10 to 25% w/w.

Stabilizers mainly act as an antioxidant is selected from tocopherols, tocopherol derivatives, ascorbic acid, sodium ascorbate, ascorbyl palmitate, 6-ethoxy-1,2-dihydroxy-2,2,4-trimethylquinoline (ethoxyquine), 3,5-di-tert-4-butyl hydroxytoluene (BHT) and tert-butyl hydroxyanisole (BHA) obtained from synthetically and naturally, rosemary extract, and a mixture thereof.

A stabilizer present in the composition is about 0.1 to 20% w/w but preferably about 1 to 5% w/w. An emulsifier used in the present invention is selected from a group of polysorbates, Sorbitan monostearate, Sucrose fatty acid ester, Propylene glycol esters of fatty acids (PGMS), Polyglycerol esters, Mono and diglycerides, Lactic acid esters, lecithins, Diacetyl tartaric acid esters, and a mixture thereof.

An emulsifier present in the composition is about 0.1 to 20% w/w but preferably about 1 to 5% w/w.

The present invention discloses the composition of selectively fat-soluble vitamins, including vitamins containing oils, provitamins, and pure or substantially pure vitamins (natural and/or synthetic) and chemical derivatives and mixtures thereof. In particular, vitamins and derivatives thereof are selected from the group consisting of vitamins A, D, E, and K. For example, the term “vitamin E” includes mixtures of synthetically or naturally occurring.

The present invention is enabled to provide the composition in the form of beadlets in an amorphous form comprising the fat-soluble vitamin, which can easily encapsulate/entrap and release the active constituents without degradation and enhance the solubility, which ultimately results in enhancement in bioavailability. As the composition comprises fat-soluble vitamins in an amorphous form, hence it is known to the fact that it results in an increase in solubility and stability.

The invention may be embodied in other specific forms without departing from the spirit or essential attributes thereof. Tins invention also encompasses all combinations of alternative aspects of the invention noted herein. It is understood that any and all embodiments of die present invention may be taken in conjunction with any other embodiment to describe additional embodiments of the present invention. Furthermore, any elements of an embodiment may be combined with any and all other elements from any of the embodiments to describe additional embodiments, in order to prepare the compositions herein above described, various preparation means available to the skilled artisan may be utilized. The amorphous composition of the present invention may be prepared by the provided forgoing examples.

The phrase “pharmaceutically and/or nutraceutically acceptable excipients” is employed herein to refer to those compounds, materials, compositions, and/or dosage forms which are within the scope of sound medical judgment, suitable for use m contact with the tissues of human beings and animals without excessive toxicity, irritation, allergic response, or other problem or complication, commensurate with a reasonable benefit/risk ratio.

The following examples are for the purpose of illustration of the invention only and are not intended in any way to limit the scope of the present invention.

### Example 1

| Sr No | Ingredient | Qty in kg | Function |
|---|---|---|---|
| 1 | Vitamin A Acetate (2.8 Mio | 0.144 | Active/Fat soluble |
| | IU/g) | | vitamin |
| 2 | Modified starch | 0.464 | Encapsulating agent |
| 3 | MCT oil | 0.144 | Solubilizer for vitamin |
| 4 | Tocopherol | 0.028 | Stabilizer |
| 5 | Sodium Ascorbate | 0.020 | Stabilizer |
| 6 | Sunflower Lecithin | 0.010 | Emulsifier |
| 7 | Water | 0.740 | Solubilizer for an |
| | | | encapsulating agent |

1. Dissolving Vit. A acetate in a weighed quantity of MCT oil in tank 1
2. Adding tocopherol and sunflower lecithin in tank 1 under stirring to form uniform dispersion.
3. Dissolve modified starch in hot water (approx. 50-60 deg) and add sodium ascorbate to form a clear gel in tank 2.
4. Keep tank 2 under high shear homogenizer and add Vit A phase slowly under homogenization to form uniform white color flowable cream/emulsion.
5. Adding additional water to the cream to make a sprayable.
6. Spray the emulsion on pre-treated starch to form uniform spherical particles of size preferably below 40 p, and bulk density between 0.4 to 0.8 g/mL.

A composition obtained as per example 1 is further analyzed by X-ray study and DSC. To ensure the obtained composition in amorphous form and the stability of the composition, provided as follows.

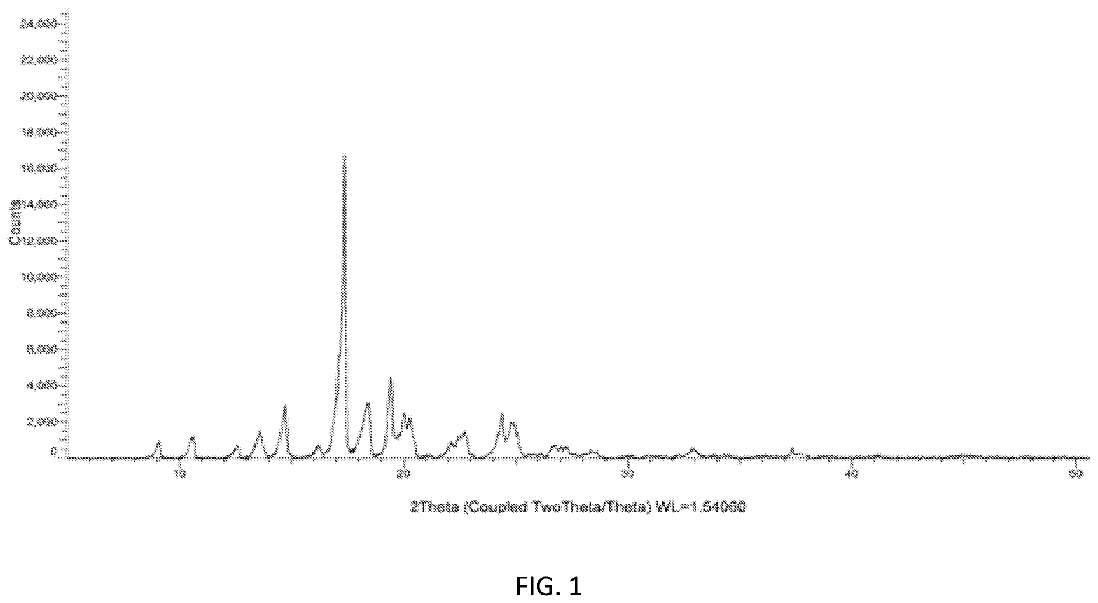

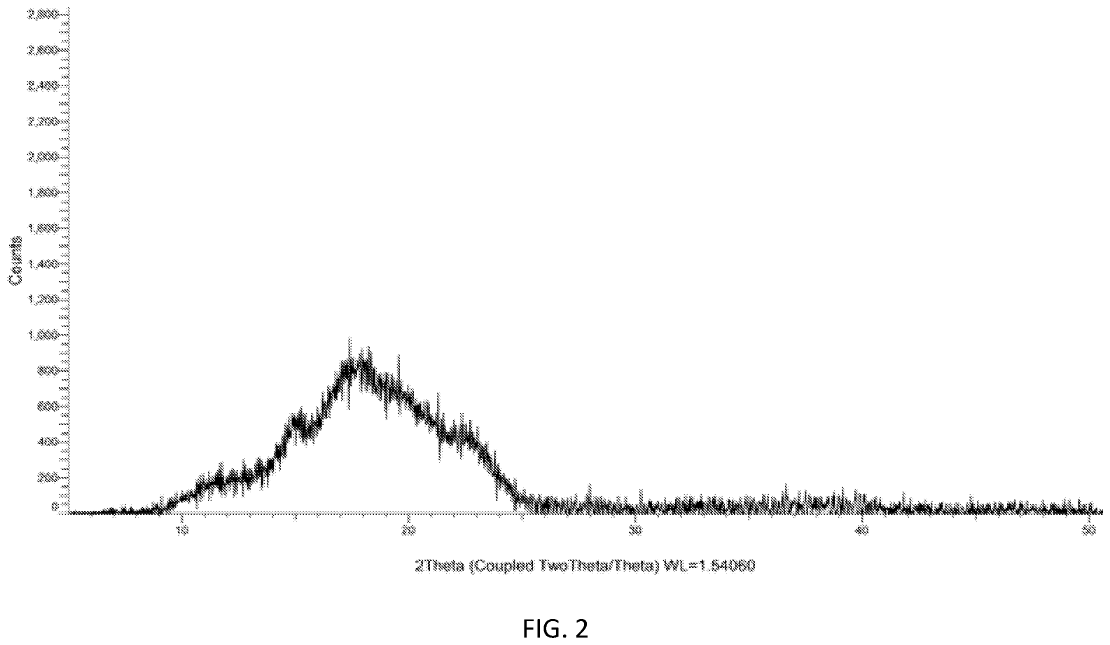

### X-Ray Diffraction Study (FIG. 1 and FIG. 2)

X-ray diffractometer (Bruker D8 Advance ECO, USA) was used to investigate the X-ray diffraction pattern of the samples. The Cu-Ka radiation source was used to form the XRD graphs (20 angles: 5° and) 30°, and voltage/current values were set to 40 kV/25 mA. Samples of plain Vit A acetate and the composition obtained as per the example 1 were run on the X-ray diffraction study. X-ray diffractogram of plain Vit A acetate and vitamin A beadlets (example 1) are shown in FIG. 1 and FIG. 2, respectively. It is seen that composition of vitamin A acetate (beadlets) showed a complete amorphous form of vitamin A compared to plain vitamin A acetate (crystalline form—Fig-1).

### DSC Procedure:

DSC analysis were performed with DSC 7020 (Hitachi, Japan). The samples were heated in covered aluminum pan and exposed to heating at a speed of 10° C./min from 30-100° C. under dry nitrogen purge (60 mL/min). Thermal analysis was performed using software Nexta analysis.

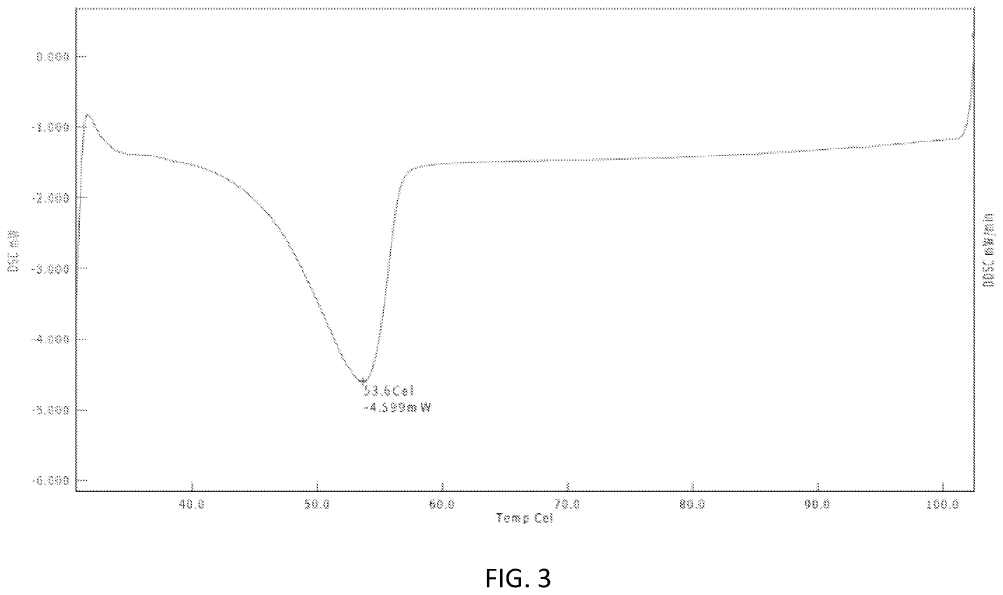

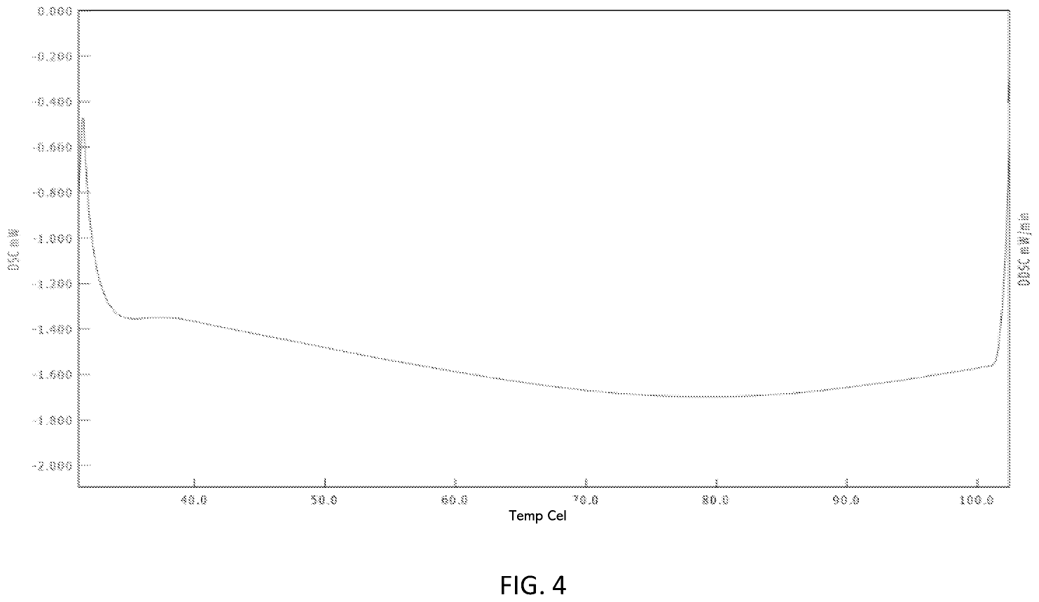

### FIG. 3 & FIG. 4

DSC thermograms of Vitamin A acetate exhibited a sharp thermal peak at 53.6° C. (FIG. 3), which is its melting point. The thermogram of Vitamin A beadlets (Example 1-FIG. 4) showed complete disappearance of the melting endothermic peak of Vitamin A acetate.

The complete disappearance of melting endothermic in fat soluble composition (Example 1) is indicative of formation of amorphous system which is resulting in highly soluble and stabilized vitamin beadlets. This may further give improved bioavailability due to its highly soluble nature.

### Stability Study of the Composition as Per Example 1

Example 1 samples were studied for stability studies at accelerated conditions of 40° C./75% RH for 6 months, which tends to consider for 02 years as per the ICH guidelines. There was no significant change in the appearance of the vitamin A acetate beadlet and the content of Vitamin A acetate.

| | | Specification | | | | |
|---|---|---|---|---|---|---|
| Sample | Test | limits | 0 day | 1 month | 3 months | 6 months |
| Example 1 | Appearance | Light yellow | Complies | Complies | Complies | Complies |
| Vitamin A | | to yellow | | | | |
| composition | | spherical | | | | |
| | | beadlets | | | | |
| | Assay (%) | 90.0-120.0 | 104.2 | 101.2 | 99.6 | 99.6 |
| | Loss on | NMT 6.0 | 4.5 | 4.3 | 4.7 | 5.1 |
| | drying (%) | | | | | |

### Example 2

| Sr No | Ingredient | Qty/kg |
|---|---|---|
| 1 | Vitamin A Palmitate (1.7 Mio IU/g) | 0.202 |
| 2 | Modified starch | 0.336 |
| 3 | MCT oil | 0.202 |
| 4 | Tocopherol | 0.040 |
| 5 | Sodium Ascorbate | 0.020 |
| 6 | Sunflower Lecithin (PC 50%) | 0.010 |
| 7 | Water | 0.740 |

### Process:

1. Dissolving Vit A palmitate in weighed qty of MCT oil in tank 1
2. Adding tocopherol and sunflower lecithin in tank 1 under stirring to form uniform dispersion.
3. Dissolve modified starch in hot water (approx. 50-60 deg) and add sodium ascorbate to form a clear gel in tank 2.
4. Keep tank 2 under high shear homogenizer and add Vit A phase slowly under homogenization to form uniform white color flowable cream/emulsion.
5. Add additional water to the cream to make a sprayable.
6. Spray the emulsion on pre-treated starch to form uniform spherical particles of size preferably below 40 p, and bulk density between 0.4 to 0.8 g/mL.

### Example 3

| Sr No | Ingredient | Qty in kg |
|---|---|---|
| 1 | Vit D3 in MCT oil (1.0 million IU/g) | 0.220 |
| 2 | Modified starch | 0.510 |
| 3 | Tocopherol | 0.040 |
| 4 | Ascorbic Acid | 0.020 |
| 5 | Tween 80 | 0.010 |
| 6 | Water | 0.740 |

### Process

1. Taking a weighed quantity of Vit D3 oil in tank 1
2. Adding tocopherol and tween 80 in tank 1 under stirring to form uniform dispersion.
3. Dissolve modified starch in hot water (approx. 50-60 deg) and add ascorbic acid to form a clear gel in tank 2.
4. Keep tank 2 under high shear homogenizer and add Vit D3 phase slowly under homogenization to form uniform white color flowable cream/emulsion.
5. Adding additional water to the cream to make a sprayable.
6. Spray this emulsion on pre-treated starch to form uniform spherical particles of size preferably below 40 p, and bulk density between 0.4 to 0.8 g/mL.

A composition obtained as per example 3 is further analyzed by X-ray study and DSC. To ensure the obtained composition in amorphous form and the stability of the composition, provided as follows.

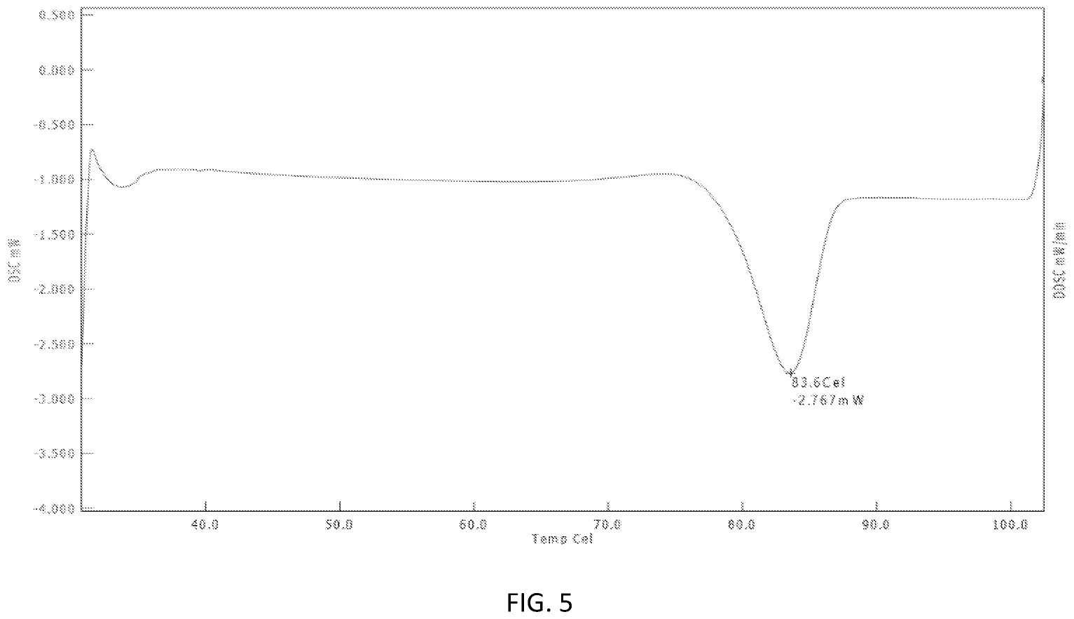

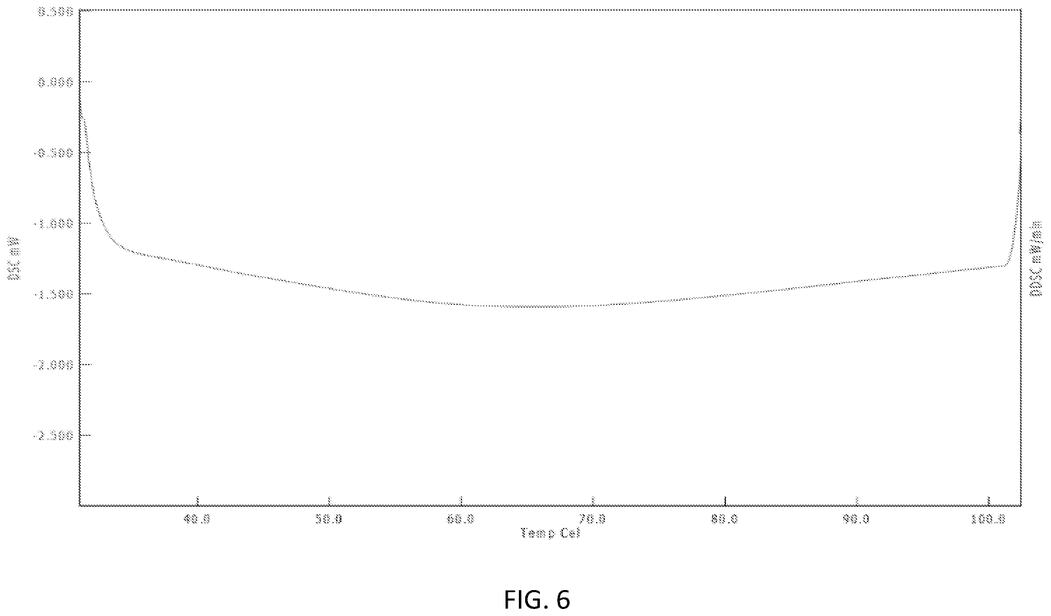

### DSC Study (FIG. 5 & FIG. 6)

DSC thermograms of Vitamin D3 crystals exhibited a sharp thermal peak at 83.6° C. (FIG. 5), which is its melting point. The thermogram of Vitamin D3 composition (beadlets-FIG. 6) showed complete disappearance of the endothermic melting peak. The complete disappearance of melting endothermic in the composition of example 3, is indicative of the formation of the amorphous system, which results in a highly soluble and stabilized composition as per example 3, which further gives improved bioavailability due to its highly soluble nature.

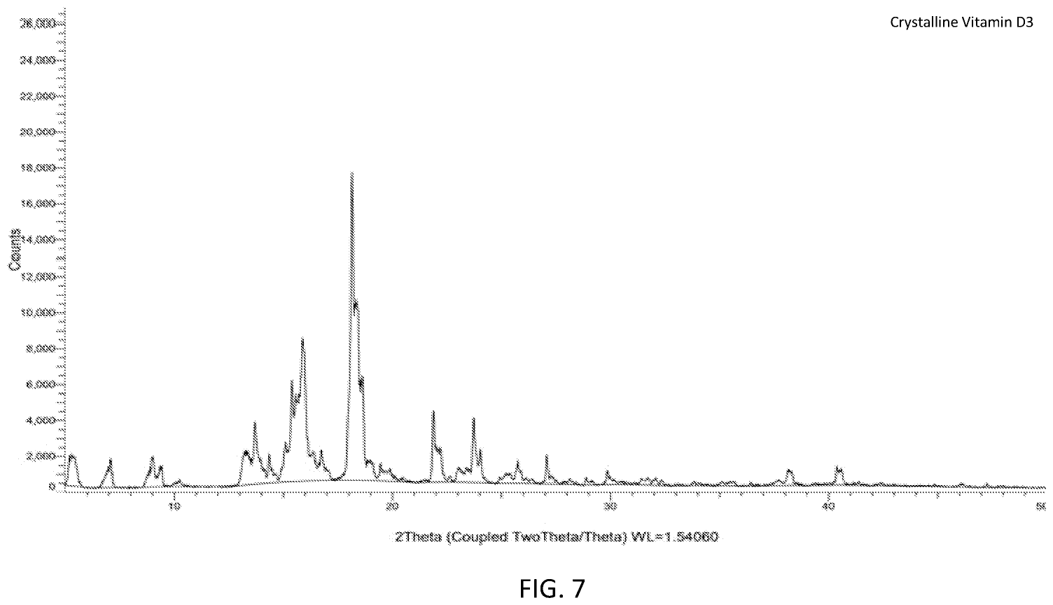

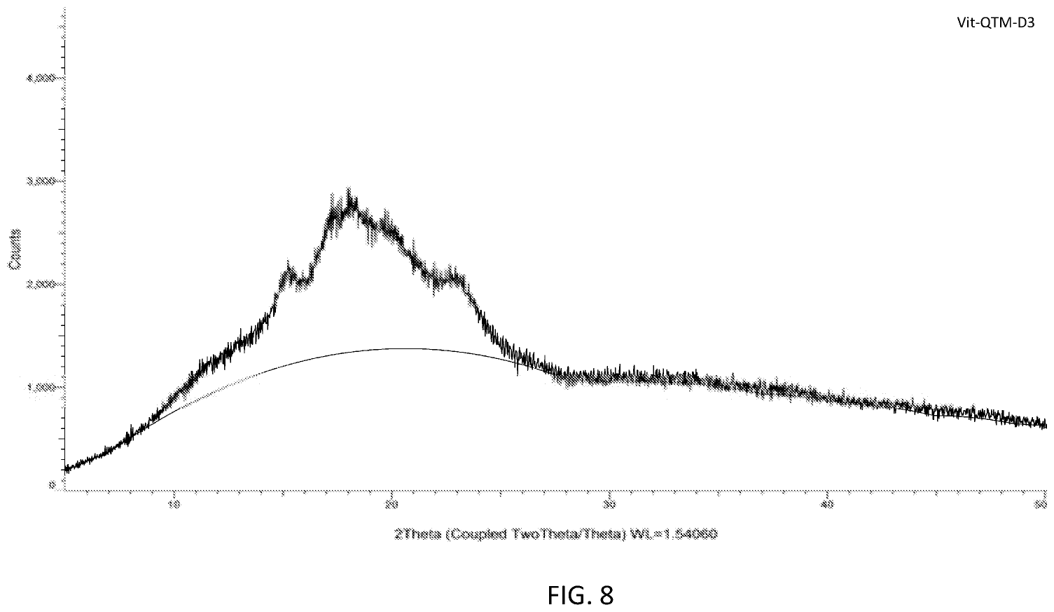

### X-Ray Diffraction Study (FIG. 7 and FIG. 8)

X-ray diffractometer (Bruker D8 Advance ECO, USA) was used to investigate the X-ray diffraction pattern of the samples. The Cu-Ka radiation source was used to form the XRD graphs (20 angles: 5° and) 30°, and voltage/current values were set to 40 kV/25 mA. Samples of plain Vit D3 and the composition obtained as per the example 1 were run on the X-ray diffraction study. X-ray diffractogram of plain Vit D3 and vitamin A composition (beadlets—Example 1) are shown in FIG. 7 and FIG. 8, respectively. It is seen that composition of vitamin D3 composition (beadlets) showed a complete amorphous form of vitamin D3 composition compared to plain vitamin D3 (crystalline form-fig-8).

### Example 4

| Sr No | Ingredient | Qty in kg |
|---|---|---|
| 1 | Vit K2-7 in MCT oil (75000 ppm) | 0.040 |
| 2 | Modified starch | 0.735 |
| 3 | Tocopherol | 0.010 |
| 4 | Sodium Ascorbate | 0.005 |
| 5 | Sunflower Lecithin | 0.010 |
| 6 | Water | 1.470 |

### Process

1. Taking weighed quantity of Vit K2-7 oil in tank 1
2. Adding tocopherol and sunflower lecithin in tank 1 under stirring to form uniform dispersion.
3. Dissolve modified starch in hot water (approx. 50-60 deg) and add sodium ascorbate to form a clear gel in tank 2.
4. Keep tank 2 under high shear homogenizer and add Vit K2-7 phase slowly under homogenization to form uniform white color flowable cream/emulsion.
5. Adding additional water to the cream to make a sprayable.
6. Spray this emulsion on pre-treated starch to form uniform spherical particles of size preferably below 40 p, and bulk density between 0.4 to 0.8 g/mL.

While the example of the invention has been described in brief in the complete application and with reference to specific embodiments thereof, it will be apparent to one skilled in the art that various changes and modifications can be made therein without departing from the spirit and scope thereof.

We claim:

1. A fat-soluble vitamin composition in an amorphous form comprising:
a) fat-soluble vitamins and/or it's derivatives in crystalline form;
b) a suitable encapsulating agent;
c) a suitable stabilizer;
d) a suitable solubilizer; and
e) a suitable emulsifier.

2. The composition, as claimed in claim 1, wherein fat-soluble vitamin composition is present in an amorphous form.

3. The composition, as claimed in claim 1, wherein fat-soluble vitamin is selected from Vitamin A acetate, Vitamin A Palmitate, Vitamin D3, Vitamin KI, and K2, and its derivatives.

4. The composition, as claimed in claim 1, wherein an encapsulating agent is selected from gelatin-like modified starch, dextrin derivatives, sugars, gums, modified cellulose, xanthan gum, acacia gum, pectin, guar, maltodextrin, alginate, and a mixture thereof.

5. The composition, as claimed in claim 1, wherein an encapsulating agent present in the composition is about 40% to about 99% w/w.

6. The composition, as claimed in claim 1, wherein a solubilizer is selected from the group of vegetable oils like palm oil, soyabean oil, coconut oil, sunflower oil, rapeseed oil, olive oil, corn oil, MCT oil, and mixture thereof.

7. The composition, as claimed in claim 1, wherein a solubilizer is present in the composition is about 5 to about 40% w/w.

8. The composition, as claimed in claim 1, wherein a stabilizer is selected from tocopherols, tocopherol derivatives, ascorbic acid, sodium ascorbate, ascorbyl palmitate, 6-ethoxy-1,2-dihydroxy-2,2,4-trimethylquinoline (ethoxy quine), 3,5-di-tert-4-butylhydroxytoluene (BHT), tert-butyl hydroxyanisole (BHA), rosemary extract, and a mixture thereof.

9. The composition, as claimed in claim 1, wherein a stabilizer present in the composition, is about 0.1 to about 20% w/w.

10. The composition, as claimed in claim 1, wherein an emulsifier selected from a group of polysorbates, sorbitan monostearate, sucrose fatty acid ester, propylene glycol esters of fatty acids (PGMS), polyglycerol esters, mono and diglycerides, lactic acid esters, lecithin, Diacetyl tartaric acid esters, and a mixture thereof.

11. The composition, as claimed in claim 1, wherein an emulsifier present in the composition is about 0.1 to about 20% w/w.

12. A method of making the composition as defined in claim 1, said method comprising the steps of:
(i) dissolving fat-soluble vitamin in vegetable oil;
(ii) a stabilizer and emulsifier added into the solution obtained in step (i) to form uniform dispersion;
(iii) dissolving encapsulating agent in hot water and stabilizer to form a clear gel;
(iv) keeping homogenization using homogenizer in step (ii) and adding step (i) solution slowly to obtain emulsion;
(v) adding required water in step (iv) to obtain a sprayable emulsion; and
(vi) spraying the emulsion obtained in step (v) on pre-treated starch to form uniform spherical particles as beadlets.
